(19) United States
(12) Patent Application Publication
(10) Pub. No.: US 2014/0028177 A1
(43) Pub. Date: Jan. 30, 2014

(54) CONTACT FOR A SPARK PLUG SYSTEM

(71) Applicants: Guido Bayard, Dortmund (DE); Christoph Nohtse, Veltheim (Ohe) (DE); Dirk Katzenellenbogen, Tiddische (DE); Martin Stolle, Wolfsburg (DE); Stefan Wasserfuhr, Marienheide (DE); Klaus Knolmayer, Walting (DE)

(72) Inventors: Guido Bayard, Dortmund (DE); Christoph Nohtse, Veltheim (Ohe) (DE); Dirk Katzenellenbogen, Tiddische (DE); Martin Stolle, Wolfsburg (DE); Stefan Wasserfuhr, Marienheide (DE); Klaus Knolmayer, Walting (DE)

(73) Assignee: PULSE ELECTRONICS GMBH, Meinerzhagen, DE (DE)

(21) Appl. No.: 14/110,455

(22) PCT Filed: Apr. 12, 2012
(86) PCT No.: PCT/EP2012/001601

§ 371 Date: Oct. 8, 2013

(30) Foreign Application Priority Data
Apr. 13, 2011 (EP) 11 003 141.6
Apr. 14, 2011 (DE) 10 2011 017 095.2

(51) Int. Cl. H01T 13/06

(52) U.S. Cl. CPC H01T 13/06
USPC 313/143; 439/890

(57) ABSTRACT

A halogen free contact arranged a between an insulation body of a spark plug and a resilient protective cap of a spark plug connector.

### BACKGROUND OF THE INVENTION

1. Field of the Invention

The invention relates to a contact for a spark plug system, comprising a spark plug and a spark plug connector, wherein the contact is arranged between an insulation body of the spark plug and a protective cap of the spark plug connector.

2. Description of Related Art

For the ignition of an ignitable fuel-air mixture in order to operate internal combustion engines functioning in accordance with the Otto principle, according to the prior art, the required ignition energy is made available by means of an arc discharge at a spark plug. For this purpose, a high voltage source is required which applies an electrical ignition voltage to the individual spark plugs of the internal combustion engine at the relevant time point. Said ignition voltage causes arcing with an ignition spark between two electrodes arranged at a defined small distance from one another. A connection between the spark plug and an electrical conductor emerging from the high voltage source is achieved by means of a spark plug connector. As an alternative to this, the spark plug connector can also be a component of the high voltage source, without the use of an additional electrical conductor.

According to the prior art, spark plug connectors are configured as silicone molded parts with an elastic protective cap and a metal connection part arranged within the protective cover for electrically contacting a corresponding connection part of the spark plug. The external protective cover serves, firstly, for fixing the spark plug connector on the spark plug and thus for ensuring a lasting contact between the two connection parts. For this purpose, when the spark plug connector is pushed onto the spark plug, the protective cover is stretched radially and is therefore held force-locked to a ceramic insulation body which surrounds the connection of the spark plug. Secondly, the close seating of the protective cover on the insulation body has a sealing effect which not only prevents any impairment of the electrical

contact between the connection parts of the spark plug and the spark plug connector by the ingress of dirt and moisture, but also prevents electrical arcing along the spark plug contour when the electrical high voltage is applied. By means of the elastic protective cover, normally electrical impulse voltages of over U=35 kV with time constants as are typical in ignition systems of motor vehicle internal combustion engines can be electrically insulated.

For spark plug connectors, according to the prior art, silicone molded parts made of methyl-vinyl-silicone rubber (VMQ) are used which are suitable, in particular, for use at temperatures of up to 230° C. These materials are also sufficiently resistant to ageing and have good chemical resistance, so that they are also fundamentally well suited to use in the engine compartment of motor vehicles.

For servicing of the internal combustion engine, the spark plug connectors must usually be removed from the spark plugs. It is therefore necessary for the spark plug connectors to create a reliable contact to the spark plug even after a plurality of plugging cycles. In order to ensure this, it is required to avoid adhesion of the protective cover to the ceramic insulation body of the spark plug which can occur, in particular, as a result of the temperature changes occurring in the engine compartment. According to the prior art, the use of a parting agent in the form of greasing or talcum-coating of the silicone molded part is therefore indispensable. These parting agents often act simultaneously as lubricants in order to facilitate pushing of the spark plug connector onto the spark plug or to prevent damage to the protective cover thereby, and can also sometimes improve the sealing effect of the protective cover. For greasing, due to the temperature loading to be expected, greases are currently used whose chemical composition is based on synthetically manufactured perfluorinated polyether (PFPE) compounds.

Based on the different constructions of commercially available spark plugs, of which several or all are intended to be compatible with any particular internal combustion engine, and the relatively great tolerances of these components, according to which, actual dimensions according to currently valid norms may well deviate from the defined nominal dimensions by several tenths of a millimeter, it is not often technically possible when using silicone molded parts made of VMQ materials, reliably to prevent the existence of any air gaps between the protective cover of the spark plug connector and the insulation body of the spark plug by design, that is, by suitable shaping of the protective cover. When a high electrical voltage is applied to the spark plug connector, electrical gas discharge phenomena, that is, partial discharges, can therefore arise in the existing hollow spaces. Said partial discharges are locally occurring corona or arc discharges in the insulation system which initially do not, or do not significantly, impair the essential functioning of the component. However, according to the most recent prior art, it is known that such partial discharges decompose the air in existing gaps and hollow spaces and the formation of ozone and—in the presence of moisture—nitric acid can occur. It is also known that when perfluorinated polyethers, as are currently used as parting agents decompose (e.g. on thermal decomposition at temperatures T>290° C.), toxic and corrosive gases can be released. Furthermore, the formation of hydrogen fluoride (HF) and carbonyl difluoride (C0₂F) is to be expected. Hydrogen fluoride together with moisture has an extremely high damaging potential because hydrofluoric acid can form, resulting in material decomposition (material softening). Even chemical-resistant VMQ materials have a significantly reduced reliability and lifespan in the presence of such severe acidity if such high levels of partial discharge are able to act for sufficiently long time periods. As a result, partial discharges lead to embrittlement and hardening of the material which, when the spark plug connector is removed for servicing of the internal combustion engine, can lead to complete failure of the component.

### SUMMARY OF THE INVENTION

Proceeding from this prior art, it is an object of the invention to provide an improved contact, arranged between a protective cover of a spark plug connector and an insulation body of a spark plug, that is able to fulfill a separating, lubricating and/or sealing function. In particular, the contact is to make possible a prolonged service life for the protective cover of the spark plug connector.

This aim is achieved with the subject matter of the claims. Advantageous embodiments are disclosed in the description of the invention below.

The above and other objects, which will be apparent to those skilled in the art, are achieved in the present invention which is directed to in a first aspect a contact for arrangement between an insulation body of a spark plug and an elastic protective cover of a spark plug connector, the contact comprising halogen free material or a fluorine-free material, or both. The material may be based on a polysiloxane composition or a polydimethyl siloxane composition.

The polysiloxane composition may comprise silicon dioxide, and the silicon dioxide may comprise particle sizes in the range of 0.1 μm to 10 μm.

In a second aspect, the present invention is directed to a spark plug connector comprising an elastic protective cover, the protective cover including a coating including halogen free material, fluorine-free material, or both.

In a third aspect, the present invention is directed to a spark plug including an insulation body surrounding an electrical contact element, the insulation body having an exterior coated with a halogen free contacting material, a fluorine-free material, or both. The material may be based on a polysiloxane composition or a polydimethyl siloxane composition.

In a fourth aspect, the present invention is directed to a spark plug system comprising: a spark plug which comprises an electrical contact element which is surrounded by an insulation body, and a spark plug connector which comprises an elastic protective cover which is pushed in sealing manner onto the insulation body of the spark plug, including a contact arranged between the insulation body and the protective cover, the contact including halogen free material, fluorine-free material, or both. The material may be based on a polysiloxane composition or a polydimethyl siloxane composition.

### BRIEF DESCRIPTION OF THE DRAWINGS

The features of the invention believed to be novel and the elements characteristic of the invention are set forth with particularity in the appended claims. The figures are for illustration purposes only and are not drawn to scale. The invention itself, however, both as to organization and method of operation, may best be understood by reference to the detailed description which follows taken in conjunction with the accompanying drawings in which:

FIG. 1 shows a spark plug system according to the invention in a partially sectional side view.

### DESCRIPTION OF THE PREFERRED EMBODIMENT(S)

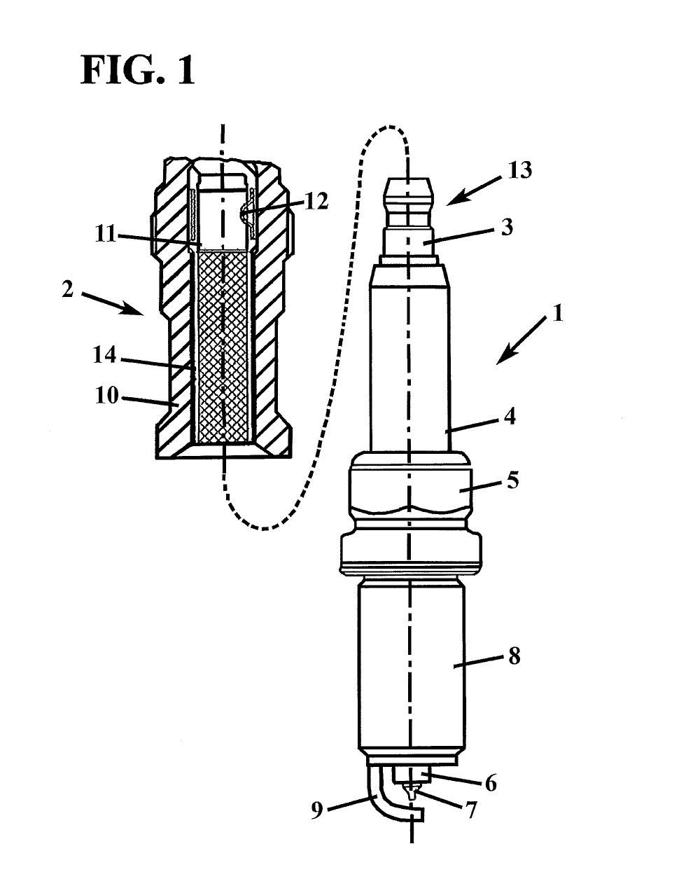

In describing the preferred embodiment of the present invention, reference will be made herein to FIG. 1 of the drawings in which like numerals refer to like features of the invention.

The core of the invention lies in the use of a halogen-free and, in particular, fluorine-free contact for arrangement between an insulation body of a spark plug of an internal combustion engine and a protective cover of a spark plug connector.

The inventive contact which is preferably arranged over a large area and particularly preferably, as far as possible, over the whole area between the insulation body and the protective cover can act there as a separating means, lubricating means and/or sealing means. By dispensing with halogens and/or halogen compounds as a constituent of the contact, the disadvantages described above associated with the perfluorinated polyether compounds conventionally used as contacting means can be prevented.

The inventive contact is preferably based on polysiloxane (silicone) and particularly preferably on polymethyl siloxane which not only is, or can be configured to be, sufficiently thermally stable (in the temperature range of relevance to spark plug connectors of approximately T=−40° C. to approximately T=200° C., but can also have a viscosity with which the desired good “adaptability” can be achieved, i.e. the inventive contact also reliably closes small, and even the smallest, hollow spaces which form between the insulation body and the protective cover and can also lead to the problematic electrical discharges described above. This viscosity also remains sufficiently constant in the relevant temperature range as given. Further relevant advantages of the inventive use of a contact based on polysiloxane are the low degradation tendency thereof, which is partially attributable to the fact that the protective covers of spark plug connectors are often also preferably configured, according to the invention, from an elastomer based on polysiloxane, so that in this respect, an advantageous alliance of materials is produced. Furthermore, polysiloxane is significantly hydrophobic, by which means the formation of acids, such as nitric acid, that can arise from the decomposition of air by partial discharges in conjunction with moisture, can be prevented.

It can also preferably be provided that the contact used according with the invention comprises silicon dioxide (silicic acid). The silicon dioxide can act, in particular, as a thickening agent in order to create—in a preferred combination with silicone oil (two-phase system)—a relatively high (preferably paste-like) viscosity of the contacting means. By this means, in particular, the workability of the contacting means can be improved.

Preferably, the silicon dioxide has a particle size in the range of approximately 0.1 μm to approximately 10 μm (highly disperse silicon dioxide). It has become apparent that silicon dioxide particles of this size can be distributed well, i.e. as homogeneously as possible, in a polysiloxane matrix.

An inventive spark plug connector comprising a protective cover which is elastic and preferably consists of a silicone rubber (VMQ) is characterized in that the interior of the protective cover is coated (wetted) with an inventive contact at least in one region and preferably over the whole region of the interior which is provided for a sealing contact with the exterior of a spark plug.

An inventive spark plug comprising an insulation body surrounding an electrical contact element is characterized in that the exterior of the insulation body is coated (wetted) with an inventive contacting means at least in one region and preferably over the whole region of the exterior which is provided for a sealing contact with the interior of a spark plug connector.

An inventive spark plug system which comprises at least one spark plug with an insulation body which surrounds an electrical contact element, and a spark plug connector with an elastic protective cover which is pushed in sealing manner onto the insulation body of the spark plug is characterized in that an inventive contact is arranged between the insulation body and the protective cover.

The layer thickness of the coating consisting of an inventive contact in the case of an inventive spark plug connector or an inventive spark plug or an inventive spark plug system is preferably in the range of 10 μm to 1000 μm.

FIG. 1 shows the essential elements of a spark plug system according to the invention in a partially sectional side view. Said spark plug system comprises a spark plug 1 and a spark plug connector 2 which can be pushed onto an upper region of the spark plug 1 in order to create an electrical contact between the spark plug 1 and an ignition voltage source (not shown).

The spark plug 1 comprises an electrically conductive terminal stud 3 which is surrounded by a ceramic insulator head 4. A hollow housing 5, within which an insulator tip 6 extends, adjoins the insulator head 4. The insulator tip 6 surrounds a central electrode 7 which is connected in electrically conducting manner to the terminal stud 3. The housing comprises a lower section with an external thread 8, by means of which the spark plug can be screwed into a corresponding internal thread of a cylinder head of an internal combustion engine (not shown). Adjoining the section of the housing having the external thread 8 is an earthing electrode 9 which is bent by 90° and ends at a defined distance from the free end of the central electrode 7, thus providing an ignition spark gap between the earthing electrode 9 and the central electrode 7.

The spark plug connector 2 comprises a protective cover 10 made of methyl-vinyl-silicone rubber and a contact element 11 integrated into the upper section of the protective cover 10. The contact element 11 is electrically conductively connected to the ignition voltage source.

For the operation of the spark plug 1, the spark plug connector 2 is pushed onto the upper end of the spark plug 1, until a locking element 12 of the contact element 11 snaps into a peripheral groove 13 of the terminal stud 3 in order to ensure an electrical contact. Alternatively, in the case of high voltage generators firmly screwed in place, in place of the locking element 12, a compression spring can also be used for contacting. The lower section of the protective cover 10 of the spark plug connector 2 thus surrounds the whole periphery of the insulator head 4 of the spark plug 1, such that the elastically deformable protective cover 10 is radially stretched. By means of the elastic stretching, a sealing seating of the protective cover 10 on the insulator head 4 is achieved. This sealing seating, firstly, ensures—in conjunction with the locking element 12 snapping into the peripheral groove—a firm hold of the spark plug connector 2 on the spark plug 1 and, secondly, seals the electrical contact between the terminal stud 3 and the contact element 11 in relation to the surroundings in order, where possible, to prevent the penetration of dirt and moisture.

The protective cover 10 is provided, over the whole area in the region where said cover comes into contact with the insulator head 4, with a coating 14 made of an inventive contacting element. The contacting element is configured as a two-phase system made of a thermostable silicone oil and non-melting highly disperse silicon dioxide (silicic acid). When the spark plug connector 2 is pushed onto the spark plug 1, the contacting element acts as a lubricant in order to improve the sliding movement of the protective cover 10 on the insulator head 4. In the plugged-together state of the spark plug system, the contacting element serves, firstly, as a sealing which fills in possible air inclusions between the protective cover and the insulator head and thereby hinders the occurrence of partial discharges and, secondly—as a result of the lubricating effect—as a separating agent which prevents adhesion of the protective cover 10 to the insulator head 4 after long use of the spark plug system.

While the present invention has been particularly described, in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

Thus, having described the invention, what is claimed is:

1. A contact for arrangement between an insulation body of a spark plug and an elastic protective cover of a spark plug connector, said contact comprising halogen free material.

2. The contact of claim 1 wherein said material is fluorine-free.

3. The contact of claim 1 wherein said material is based on a polysiloxane composition.

4. The contact of claim 3 wherein said material is based on a polydimethyl siloxane composition.

5. The contact of claim 3 wherein said polysiloxane composition comprises silicon dioxide.

6. The contact of claim 5 wherein said silicon dioxide comprises particle sizes in the range of 0.1 μm to 10 μm.

7. A spark plug connector comprising an elastic protective cover, said protective cover including a coating including halogen free material.

8. A spark plug including an insulation body surrounding an electrical contact element, said insulation body having an exterior coated with a halogen free contacting material.

9. A spark plug system comprising:
a spark plug which comprises an electrical contact element which is surrounded by an insulation body, and
a spark plug connector which comprises an elastic protective cover which is pushed in sealing manner onto the insulation body of the spark plug, including a contact arranged between the insulation body and the protective cover, said contact including halogen free material.

10. The contact of claim 2 wherein said material is based on polysiloxane composition.

11. The contact of claim 10 wherein said material is based on polydimethyl siloxane composition.

12. The contact of claim 10 wherein said polysiloxane composition comprises silicon dioxide.

13. The contact of claim 12 wherein said silicon dioxide comprises particle sizes in the range of 0.1 μm to 10 μm.

14. The spark plug of claim 7 wherein said coating includes fluorine-free material.

15. The spark plug of claim 7 wherein said coating includes a polysiloxane composition or a polydimethyl siloxane composition.

16. The spark plug of claim 15 wherein said polysiloxane composition includes silicon dioxide.

17. The spark plug of claim 16 wherein said silicon dioxide comprises particle sizes in the range of 0.1 μm to 10 μm.

18. The spark plug of claim 8 wherein said exterior contact coating material is fluorine-free.

19. The spark plug of claim 8 wherein said exterior contact coating material is based on a polysiloxane composition.

20. The spark plug of claim 8 wherein said exterior contact coating material is based on a polydimethyl siloxane composition.

21. The spark plug of claim 19 wherein said polysiloxane composition comprises silicon dioxide.

22. The spark plug of claim 21 wherein said silicon dioxide comprises particle sizes in the range of 0.1 μm to 10 μm.

23. The spark plug system of claim 9 wherein said contact material is fluorine-free.

24. The spark plug system of claim 9 wherein said contact material is based on a polysiloxane composition.

25. The spark plug system of claim 9 wherein said contact material is based on a polydimethyl siloxane composition.

26. The spark plug system of claim 24 wherein said polysiloxane composition comprises silicon dioxide.

27. The spark plug of claim 26 wherein said silicon dioxide comprises particle sizes in the range of 0.1 μm to 10 μm.
